(19) United States
(12) Patent Application Publication
(10) Pub. No.: US 2015/0334984 A1
(43) Pub. Date: Nov. 26, 2015

(54) ENGINEERED ABSORBENT ANIMAL BEDDING

(71) Applicant: Glenn Lee Ruesswick, Camden, ME (US)

(72) Inventor: Glenn Lee Ruesswick, Camden, ME (US)

(21) Appl. No.: 14/704,635

(22) Filed: May 5, 2015

Related U.S. Application Data
(60) Provisional application No. 61/988,860, filed on May 5, 2014.

(51) Int. Cl. A01K 1/015

(52) U.S. Cl. CPC A01K 1/0155

(57) ABSTRACT

Animal bedding materials are described that comprise fragments of paper or other cellulosic materials that are contorted/bent/folded into three dimensional shapes which intertwine. The contorted/bent/folded individual pieces enclose a large void space relative to the surface area of the pieces. Intertwining of the individual pieces further increase the void space. The result is an animal bedding material that quickly captures and immobilizes relatively large amounts of aqueous liquids. Consequently, the surfaces are macroscopically dry to the touch, and less likely to promote skin irritation in animals. This structure, based on contorted/bent/folded intertwined fragments, inherently creates high loft, thus providing underfoot comfort for animals as well as thermal insulation. Manufacture of these engineered bedding materials is partially limited by shipping costs of the bulky raw materials and of the finished products so solutions to these impediments are also described.

### BACKGROUND OF THE INVENTION

Animal bedding materials gathered from local sources have been used for thousands of years. They are usually cellulosic and may include wood by-products (pellets, shavings, sawdust, chips), paper strips, corrugated cardboard strips, straw, hay and cotton by-products. They are mostly unaltered and unrefined, and not used in combination with each other. Such products generally have insufficient loft, so liquid absorbency and thermal insulation are inadequate, requiring frequent changes of bedding to maintain a dry environment. Beddings sourced from wood by-products may experience shortages when the demand for fuel pellets is high.

### SUMMARY OF THE INVENTION

Given the deficiencies of existing animal bedding products, there is a need for an economical, sustainable bedding that achieves superior loft through macroscopic geometric factors. Such an engineered product increases fluid capture capacity while retaining dry surfaces, increases thermal insulation and presents a mechanical structure that is soft and resilient underfoot for animal comfort. Less bedding material is required to maintain a dry environment for the animal.

A key factor that distinguishes the improved bedding material disclosed herein from other bedding materials is that it fundamentally changes the kinetics of how animal urine is immobilized by the bedding material. The microfilament-porous structure also increases the amount of urine that is captured while retaining a nominally dry surface.

The bedding material disclosed herein can adsorb/absorb more than 5 times, 10 times or 20 times its weight in aqueous liquids such as animal urine and can be removed without leaving free flowing liquid behind. The material may be essentially free-flowing when dry but when wet becomes a uniform mass that can be easily removed in a single piece with a shovel/manure fork or other simple tool. The cellulosic fragments that comprise the bedding may be intertwined by including folds in fragments that are able to fold around and encompass adjacent pieces. Individual fibers extending from the edges of the cellulosic materials can intertwine with the corresponding fibers of adjacent fragments to form a uniform single mass of bedding material. This can be aided by moisture and the resulting increase in surface tension between fibers of different fragments that come into contact with each other.

This disclosure describes a cellulose-based material having a unique three dimensional structure. Such examples are only illustrative because the bedding materials of this disclosure are not limited to use with equine; they may be used with other domestic animals and captive non-domestic animals.

Bedding materials typically utilize aqueous liquid sorption. This is a multistep process:

1. Adsorption onto hydrophilic surfaces,

2. Absorption into the surface,

3. Diffusion into the interior of the absorbent (often a cellulosic material).

To ensure a healthy environment for the animal, the bedding products now in use are changed frequently. This is a necessary precaution because diffusion into the interior of the absorbent (Step 3) is too slow to maintain dry bedding.

The engineered bedding materials described herein minimize this deficiency by maximizing the surface area; a high percentage of the absorbent volume in the bedding material is in close proximity to a surface.

A second and possibly more important distinction between the bedding material of this disclosure and competitive materials is based on its microstructure. The thin cellulosic strands in this absorbent animal bedding form a structure that encapsulates a network of interconnected voids. When contacted by an aqueous liquid, surface tension immediately draws the liquid into these interior voids. Thus microvoids that are intrinsic to the structure of this described absorbent animal bedding become reservoirs which stabilize droplets under an exterior layer of cellulose. Note that the amount of water captured by this structure is much greater than would be expected by sorption into normal cellulose-based materials. The result is an absorbent animal bedding surface that is macroscopically dry to the touch and less likely to promote skin irritation in animals.

### DETAILED DESCRIPTION OF PREFERRED EMBODIMENTS

Some aspects and embodiments are directed to animal bedding. The animal bedding described herein comprises comminuted cellulose based products such as cardboard (including corrugated cardboard), kraft paper, newsprint, copy paper, etc. In these embodiments, cellulose products were selected because they exhibit or demonstrate the following attributes, characteristics, properties and/or abilities:

Volume

Surface area

Adsorption

Absorption

Structural strength

Porosity

Void creation

Void retention/maintenance

Memory/resiliency

In the following discussion, the terms piece and fragment are equivalent, as are their plural forms. In some embodiments there is a cardboard to newsprint ratio of at least 2:1, 3:1, 4:1, 5:1 or 10:1. As described herein, relatively small strips/cuts of uniform and/or non-uniform pieces of paper and/or cardboard are contorted/bent/folded into an engineered three dimensional shape. As a result, each piece has a particular surface area to volume ratio, volume to interstitial space ratio, and tensile strength to enable it to be more absorbent than a non-contorted piece/fragment. Moreover, adjacent pieces of paper and/or cardboard intertwine due to their angular folds/contortions and cause interlocking of the pieces. Voids form between the adjacent pieces/fragments. These ratios and the shape of the fragments of paper and/or cardboard allow for a substantial amount of water to be absorbed and adsorbed by the bedding and in the voids. As discussed below, liquid may then be “pulled” into the voids due to capillary action, porosity of the material, etc.

By way of example, and not meant to be limiting, assume that the bedding is comprised of uniform fragments of paper that, when in planar form, measured 1 cm ×1 cm and being 0.01 cm thick. In this example the crumpled/bent/contorted fragment is a rough sphere with a radius of 0.25 cm. The resulting surface area for the fragments is calculated based on Equation (1):

SA =L×W Equation (1)

Where (SA) is the surface area and (L) is the length of the fragment and (W) is the width of the fragment.

Thus,

SA =(1 cm ×1 cm) ×2 =2 cm² Equation (2)

We multiply the result of Equation 1 by 2 because each fragment has opposed surfaces and each surface can absorb water.

The volume of the fragment is defined by the volume of the smallest imaginary sphere capable of holding the example fragment, see Equation (3),

V =4/3 πr³ Equation (3)

Where (V) is volume and (r) is the radius of the sphere. Thus,

V =4/3 ×π×(0.25 cm)³ =0.06542 cm³ Equation (4)

To determine the surface area to volume ratio,

SA/V Equation (5)

Where SA is the surface area determined in Equation (2) and V is the volume determined in Equation (4). Thus,

2 cm²/0.06542 cm^{3 =}30 cm⁻¹ Equation (6)

To determine the interstitial space to volume ratio we must first determine the difference between the volume of the sphere and the volume of the fragment and the volume of the paper.

V_{delta} =V −V′ Equation (7)

Where (V_{delta}) is the difference between (V) as derived in Equation (4) and (V′) which represents the actual volume of the paper (i.e., prior to deformation). V′ may be calculated as,

V′=L ×W ×H Equation (8)

Where (L) is the length of the fragment, (W) is the width and (H) is the height/thickness. Thus, for our example,

V′=1 cm ×1 cm ×0.01 cm =0.01 cm³ Equation (9)

Thus using Equation (10) with the computed values for our example,

V_{delta}=0.06542 cm³−0.01 cm³=0.05542 cm³ Equation (10)

Using V_{delta} we may then derive the interstitial space to volume ratio using Equation (11),

V_{delta}/V =0.05542 cm³/0.06542 cm³=0.85 Equation (11)

Accordingly, this ratio may be used to determine the amount of “void” space the fragment has. As discussed below, these voids may be used to increase absorbency of the bedding material by trapping water.

The above example used paper with thickness of 0.01 cm. However, in other embodiments the paper can be as thin as less than 0.1 cm, less than 0.05cm or less than 0.005 cm In other embodiments the cellulosic material may be thicker than 0.1 cm, thicker than 0.2 cm, thicker than 0.3 cm or thicker than 0.635 cm.

Some example fragment dimensions that exhibit desired moisture retention effect is, for example, 0.1 to 10 cm, 0.2 to 5 cm, 0.1 to 3 cm or 0.1 to 2 cm, which includes surface areas ranging from 0.02 cm² and 8 cm², respectively. To this end, fragments with these dimensions and an area to volume ratio of less than 100 cm⁻¹ exhibit substantial absorbency of liquid. In addition, in some embodiments paper and cardboard fragments having a L/W ratio less than 10, less than 5, less than 3 or less than 2 and a volume to interstitial space ratio (Equation 11) of less than 2, less than 1.5, less than 1, less than 0.9, less than 0.75 or less than 0.5 may be preferred.

High volume manufacture of the engineered animal bedding materials described herein is difficult because the cellulosic raw materials are bulky and not always available from low cost local suppliers. Shipping costs also limit market size because the final product is bulky. Therefore, this invention also includes techniques that enable high manufacturing volumes of these engineered bedding materials, even when the users are geographically dispersed.

### Manufacturing & Product Details

Start with large, flat, planar pieces of cellulosic material such as paper products. These paper products could include cardboard, kraft paper, newsprint, recycled paper products, etc. In at least one embodiment, the paper product includes corrugated cardboard. The engineered animal bedding described herein is taken through a series of size-reduction steps, (the entire time striving for minimum fines through the use of cutting processes and fines removal techniques vs. other traditional processes and machinery that impart random force upon the feedstock, resulting in irregular pieces and fines). The difference is cutting vs. thrashing/smashing/fracturing where the pieces lose their structure. The final size/shape altering step is to subject relatively small (e.g., less than 2 cm in the flat) pieces of feedstock to a step that transforms material from a relatively 2-D shape to one exhibiting an extensive 3-D profile/shape. The 3-D shape is one that has been manufactured with a great deal of roughened and angular surfaces (facets) that exhibit the propensity to attach themselves to each other in an intertwined manner. In various embodiments, roughening the facets and edges exposes the porous structure of the cellulosic material, and thus, increases absorption. This intertwining nature changes how the individual pieces create a unified mass which tends to stay together. It is as if there is rebar embedded in the matrix, but also unified because of the multi-faceted nature of the material.

The size of the individual pieces (especially the more structural cellulosic material) is what dictates the spacing of the individual pieces in the mass and therefore the resulting voids that are created. The 3-D shape discussed earlier, tied to the angular shape of individual objects making up the sides of those voids, results in a void that can only be described as an object that cannot be identified by a typical shape identifier as it falls outside the normal definitions of angle, plane, incidence, etc. It is this vast variation in angularity that allows these voids to be so quickly and completely wetted-out through adsorption and absorption. Because of the surface forces exhibited by the hydrophilic material (e.g., cardboard, etc.), the wetted mass is reluctant to allow the urine, or other aqueous liquid, to follow gravity as it normally would.

In one embodiment, the very structure that creates this mass and these voids also creates an object that has tremendous cohesiveness (produces a mat where the material maintains broad contact area with the stall floor and the urine that is deposited on it) and resiliency at the same time. This nature creates a shape that has a great deal of loft and memory. The loft provides comfort through cushion, thermal insulation, draft control, etc. The memory acts like the structure in a sponge. But for the purpose of discussing the water/liquid retention, because the mass wants to return to its original loft height and in doing so it has the ability (read need) to return the voids to their original shape, therefore hemi-wicking the liquid urine back into the voids.

In one embodiment, the bedding material intertwines to form a mat-like structure which keeps material together on the stall floor.

In one embodiment, zeolite may be sprinkled and/or mechanically added to the bedding material. Zeolite may be added at various stages of production.

In one embodiment, lemongrass may be added. Lemongrass provides insect repellency properties.

In one embodiment, lavender may be added. Lavender provides a pleasant odor and calming properties.

In one embodiment, mineral oil may be added for hoof health.

In one embodiment, other minerals or essential oils may be added for their specific beneficial properties.

In one embodiment, the bedding material may be subjected to steam and/or other methods to remove pathogens from the material.

In one embodiment adjusting the moisture content of the bedding material will contribute to the resiliency of the material and tend to reduce fines or dust.

In one embodiment, dust is removed through continuous and vigorous dust extraction which contributes to cleaner product.

In some embodiments, the facets/folds/voids/creases and ridges fortify the paper of the bedding material and increase its tensile strength. A paper fragment with a fold angle of 0 degrees is completely folded back on itself. An unfolded flat piece of paper has a fold angle of 180 degrees. The paper fragments may include folds of less than 90 degrees, less than 75 degrees, less than 60 degrees, less than 45 degrees or less than 30 degrees.

The characteristics of the engineered absorbent animal bedding described herein are associated with the properties of the various cellulosic based paper materials (cardboard and newspaper) which have been altered through a process of grinding and mixing which creates unique characteristics. Unique machine processing methods grind the different paper types such that when they're combined in different ratios and/or with the addition of non-paper additives they produce very unique matrices. The result is a character that is greater than the individual characters of each ingredient; a synergy that is not unlike concrete, FRP, stressed skin or papier-mâché. The properties that we see enhanced are adsorption, absorption, capillary action, cohesion, adhesion, evaporation, hemi-wicking and lofting.

Animal bedding materials are often based on minimally processed cellulosic materials and exhibit marginal properties. Substantial technical know-how and capital equipment is required in order to produce a bedding product that overcomes these deficiencies. This is a formidable barrier because a state-of-the-art bedding manufacturing facility may include hammer-mills, cutters, choppers, grinders, mixers, filtering units to minimize fines, additive tanks, bins and metering equipment, weigh scales, packaging equipment, process controls, noise mitigation and an integrated materials-handling system. Even when these are available, shipping costs make it cost-prohibitive to obtain raw materials from distant suppliers. Similarly, finished product shipping costs make it impractical to service distant customers. Thus, animal bedding suppliers cannot achieve the economies of scale required to offer high quality bedding at a reasonable price.

To produce the improved engineered animal bedding described herein the limitations described above are overcome by mounting the carefully selected manufacturing equipment on mobile platforms. These platforms can be re-positioned by road, rail, water or air. Depending on the design throughput, a complete process line may utilize one or more co-located platforms.

In one embodiment, a central facility with key technical know-how and support may produce the animal bedding product manufacturing systems on mobile platforms. Each such system may be different because it is designed for the specific needs of a particular site. Upon completion, the system would be shipped to that site where it will utilize locally available raw materials and produce bedding specific to the needs of the animals near that site.

Adsorption is the adhesion of molecules from a gas, liquid or dissolved solid to a surface. This process creates a film of (the adsorbate) on the surface of the adsorbent. This process differs from absorption in which a fluid, the adsorbate, permeates or is dissolved by a liquid or solid, the absorbent. Absorption is where a fluid permeates or is dissolved by a liquid or solid. It is a condition in which something takes in another substance. Capillary action is the ability of a liquid to flow in narrow spaces without the assistance of external forces like gravity. The effect can be seen in drawing up liquids between the hairs of a paintbrush, in a thin tube, and porous materials such as paper. It occurs because of the intermolecular forces between the liquid and surrounding solid surfaces. If the diameter of the tube is sufficiently small, and the combination of surface tension (which is caused by cohesion within the liquid) and adhesive forces between the liquid and container act to lift the liquid. In short, the capillary action is due to the pressure of cohesion and adhesion which causes water to wick against gravity.

Cohesion is the action or property of molecules sticking together, being mutually attractive. This is an intrinsic property of a substance that is caused by the shape and structure of its molecules which makes the distribution of orbiting electrons irregular when molecules get close to one another, creating electrical attraction that can maintain a macroscopic structure such as a water drop. In other words, cohesion allows for surface tension, creating a “solid like” state upon which light (in weight) or low- density materials can be placed. Cohesion is where water is attracted to water. Water has the highest cohesive force of the nonmetallic liquids. It clumps together the positive and negative charges of the hydrogen and oxygen atoms making water molecules attracted to each other.

Adhesion is where water is attracted to other substances. The larger the surface area of contact between a liquid in a solid, the higher the adhesion. Prime Equine has a very large surface area created by our process and therefore strong adhesive forces.

Wetting is the ability of a liquid to maintain contact with a solid surface, resulting from intermolecular interactions that arise when the two are brought together. The degree of wetting (wettability) is determined by a force balance between adhesive and cohesive forces.

What is claimed:

1. An engineered animal bedding material comprising:
a plurality of cellulosic fragments, at least a first group of the fragments including folds of less than 90 degrees and at least a second group of the fragments positioned at least partially within the folds of the fragments of the first group, the fragments of the first group having a length that is less than three times the width of the fragment, wherein the fragments have a surface area to volume ratio of less than 100 cm⁻¹.

2. The animal bedding material of claim 1, wherein the cellulosic fragments of group 1 are comprised of at least one of cardboard, Kraft paper, and newsprint

3. The animal bedding material of claim 1, wherein the cellulosic fragments of group 1 are comprised of paper or cardboard having a thickness between 0.005 cm and 0.635 cm.

4. The animal bedding material of claim 1, wherein the cellulosic fragments of claim 1 have a surface area between 0.02 cm² and 8 cm².

5. The animal bedding material of claim 1, wherein the cellulosic fragments of group 1 have a volume to interstitial space ratio of less than 0.9.

6. The animal bedding material of claim 1, wherein the cellulosic fragments of group 1 are intertwined with adjacent deformed fragments.

7. The animal bedding material of claim 1, wherein the cellulosic bedding material includes 10 times its weight in water wherein the water is fully adsorbed/absorbed by the bedding material and there is no visible free-flowing liquid.

8. The animal bedding material of claim 1, wherein the animal is a domestic animal.

9. The animal bedding material of claim 1, wherein the animal is a captive non-domestic animal.

10. The animal bedding material of claim 1, wherein the animal is a lab rodent.

11. The animal bedding material of claim 1 wherein the animal is a farm animal.

12. An animal bedding material comprising deformed fragments of cellulose as its primary constituent (by weight) plus additives comprising zeolite, lemongrass, mineral oil, lavender or other minerals or essential oils.

13. An animal bedding assembly comprising:
deformed fragments of cellulose as its primary constituent (by weight) plus at least two of the following: zeolite, lemongrass, mineral oil, lavender or other minerals or essential oils.

14. The assembly of claim 13 wherein the surface is dry to the touch after dosing it with an aqueous liquid.

15. An apparatus comprising:
equipment designed to manufacture animal bedding comprising deformed fragments of cellulose and, where said equipment is mounted on at least one mobile platform.

16. The apparatus of claim 15 where the animal bedding contains at least two non-cellulosic additives selected from zeolite, lemongrass, mineral oil, lavender, or other minerals or essential oils.

17. Animal bedding produced by the apparatus of claim 15.

18. Animal bedding produced by the apparatus of claim 15 where the animal bedding comprises at least two non-cellulosic additives selected from zeolite, lemongrass, mineral oil, lavender or other minerals or essential oils.

19. A method of producing animal bedding as defined in claim 13, where the process equipment is installed on at least one mobile platform.
